(19) United States
(12) Patent Application Publication
(10) Pub. No.: US 2004/0006445 A1
(43) Pub. Date: Jan. 8, 2004

(54) Number label embedded with antenna tag for measuring race runner's time records via wireless identification, and runners' time records measurement method and system using the same

(76) Inventor: Min-ho Paek, Seoul (KR)

Correspondence Address: NIXON & VANDERHYE P.C., 1100 North Glebe Road, 8th Floor, Arlington, VA, 22201, US

(21) Appl. No.: 10/259,824

(22) Filed: Sep. 30, 2002

(30) Foreign Application Priority Data
Jul. 4, 2002 (KR) 2002-38559

(51) Int. Cl. G04F 1/00; G04F 3/00; G04F 5/00; G04G 5/00; G04G 7/00; G04F 7/00; G04F 8/00; G04F 10/00; G06F 15/00; G04G 15/00; G06F 17/40

(52) U.S. Cl. 702/178

(57) ABSTRACT

A number label embedded with an antenna tag for measuring a runner's time record using wireless identification (ID) at a recording race such as a marathon or walking race, and a runner's recording measurement method and system using the same are provided. There was a number label having a bar code in the past. However, if a bar code is screened by the body of a person who is attached with a bar code number label or the other user's body when a bar code reader or bar code scanner recognizes the bar code number label, the bar code may not be decoded. To solve this defect of the bar code wireless identification, there has been a technology of measuring and managing runners' IDs and time records, in which an antenna tag having a predetermined ID is attached to runners' bodies, respectively, for example, a radio frequency (RF) chip is attached to each runner's body, and then the antenna tag communicates with an antenna array to thus perform a wireless identification. In the case of the RF tag technology, race runners should attach both an antenna tag and a number label, respectively. Accordingly, to remove the cumbersome burden attaching both the antenna tag and the number label, a number label embedded with an antenna tag is provided. For this purpose, when a race runner's number label is made according to a predetermined standard, an antenna tag having an antenna coil and an electronic tag is embedded and integrated in the number label, in which the number label has a space where a race runner's number is printed. A race runner's time record is measured through a wireless ID identification process between the antenna tag embedded number label and an antenna array. Here, since the number label is usually attached on the chest and back of the race runner, the antenna array may be preferably installed over the head of the race runner in the form of a goal-post or an iron-bar. Also, it is preferable to use a step-board shaped antenna array together with a goal-post shaped antenna array for small race runners. Accordingly, a database for IDs and time records of race runners is made up in an integrated database management host computer, in order to manage the IDs and the time records. As a result, race runners' time records can be efficiently and accurately measured in time at a race where a multitude of race runners participate. Also, since race runners need not safekeep and attach antenna tags in addition to number labels, respectively, but have only to attach the antenna tags on the bodies, burdens of race runners are reduced and a manufacturing cost for the number labels and the antenna tags of sponsors is saved.

### BACKGROUND OF THE INVENTION

1. Field of the Invention

The present invention relates to a number label embedded with an antenna tag for measuring a runner's time record using wireless identification (ID) at a recording race such as a marathon or walking race, and a runner's recording measurement method and system using the same, and more particularly, to an antenna tag embedded number label, and a runner's recording measurement method and system using the same, in which a number label is embedded and integrated in an antenna tag when the number label is fabricated to be attached on the upper cloth of each race runner.

2. Description of the Related Art

Time records of runners who pass at the final point or each measuring point are measured manually by race operators at a race such as a short marathon race of 5 km, 10 km, etc., a half-course marathon race, a full-course marathon race, and a walking race. The race operators identify runners' personal data such as back numbers, and record the times counted by particular counters as runners' time records. In this case, when a number of race runners pass at a measuring point all at a time, it is difficult to measure the time record of each race runner accurately. Also, when race operators check ranks or time records of race runners and then inform the race runners of the checked results, it takes long time to arrange and obtain official time records of the race runners. As a result, it is defective to take long time until race runners are informed of their official time records.

As described above, since it is difficult to measure and report a time record of each race runner at a race where a number of persons participate as in a marathon race, technologies of measuring time records of race runners electronically through wireless identification have been being developed and used. The wireless identification electronic record measurement technologies are largely classified into a bar code record measurement system using a bar code attached on the body of each race runner and a bar code reader or scanner for reading the bar code wirelessly, and a wireless record measurement system using a radio frequency (RF) chip having an antenna tag attached on the body of each race runner and an antenna array for identifying an identification of each race runner.

The bar code record measurement technology is disclosed in U.S. Pat. No. 5,245,162 issued on Sep. 14, 1993, and U.S. Pat. No. 5,436,611 issued on Jul. 25, 1995. Since a readable distance of laser beams in the race runner's time record measurement technology using a bar code reaches about 5 meters, the bar code is applied in each number label in order to measure the time record of each race runner. However, in the case of the bar code wireless record measurement technology of identifying each runner and measuring a time record of each runner, since a bar code reader or a bar code scanner transmits a transmission signal such as laser beams to a bar code number label and reads a reflection signal reflected from the bar code, the bar code reader may not decode the bar code if the bar code is screened by his or her body or the other race runners.

The RF chip time record measurement technology can solve the defects of the bar code time record measurement technology. RF chips are chiefly used for bidirectional communications technology through wireless identification, in order to measure a time record of each race runner. The RF chip wireless record measurement technology is disclosed in Korean Laid-open Publication No. 1999-78504 published on Nov. 5, 1999, which was registered as a Korean Patent Registration No. 10-312188 to the same applicant. Also, the RF chip wireless record measurement technology is disclosed in U.S. patent application Ser. No. 09/907,640 filed on Jul. 19, 2001, of which the priority applications are Korean Patent Application No. 2001-20040 and Korean Utility Model Application No. 2000-20699 filed by the same applicant. In the case of the RF chip wireless record measurement technology, an antenna tag having a predetermined identification (ID) is attached on the body of each race runner, and the ID and time record of each race runner is measured and managed through wireless identification between the antenna tag and an antenna array. The race operator fabricates a RF chip having an antenna tag in addition to a number label and distributes the RF chip and the number label to each race runner, and each race runner should attach the antenna tag and the number label separately.

As described above, the existing wireless identification time record measurement systems have problems of a wireless identification obstacle due to screening of a bar code in the case of a bar code wireless identification time record measurement technology, and a cost increase due to fabrication of a RF chip having an antenna tag and a number label and a burdensome attaching the RF chip and the number label separately, in the case of a RF chip time record measurement system.

### SUMMARY OF THE INVENTION

To solve the above problems, it is an object of the present invention to provide an antenna tag embedded number label in which an antenna tag having an antenna coil and an electronic tag is embedded and integrated in a number label.

It is another object of the present invention to provide an antenna tag embedded number label which can be fabricated cost effectively, in which an antenna tag having an antenna coil and only a key value of each race runner is embedded and integrated in a number label to fabricate a sheet of the antenna tag embedded number label, and only a key value of each race runner is enabled and transmitted by an antenna array when each race runner attaching the number label participates in a race, to thereby process a time record with a time record measurement system.

It is still another object of the present invention to provide an antenna tag embedded number label which can be fabricated cost effectively, in which an antenna tag having an antenna coil and only a key value of each race runner is embedded and integrated in a number label to fabricate a sheet of the antenna tag embedded number label, and then an entry number of each race runner participating in the race is printed on the sheet of the antenna tag embedded number label, without requiring to print numbers of race runners in advance on the number labels, to thereby simplify fabrication of the number labels and re-use the number labels on which numbers are not printed, and in which only a key value of each race runner is enabled and transmitted by an antenna array when each race runner attaching the number label participates in a race, to thereby process a time record with a time record measurement system.

It is yet another object of the present invention to provide a time record measurement system and method using an antenna tag embedded number label for measuring a time record of each runner through wireless identification, in which only an identification (ID) of each race runner is wirelessly identified from the antenna tag embedded number label and then a time record is combined and recorded in the ID when the ID has been identified, without measuring each race runner passing a time record measuring point and a time record of the race runner manually by a race operator, and thus all race runners passing through the measuring point and the time records are cost-economically made into a database, to accordingly inform all race runners of a time record and rank of each race runner, along a race running site or through an external communications terminal.

To accomplish the above object of the present invention, there is provide an antenna tag embedded number label comprising: an antenna tag having an antenna coil wirelessly power activated by an external antenna array; and an electronic tag transmitting a stored key value by the activated antenna coil, wherein the antenna coil and the electronic tag are embedded and integrated in the number label, when the number label is fabricated according to a predetermined standard so as to be attached on the chest or back of each race runner to see an entry number of each race runner.

There is also provided a time record measurement method using an antenna tag embedded number label for measuring a time record of each race runner through wireless identification, the time record measurement method comprising the steps of: attaching the antenna tag embedded number label on the chest or back of each race runner who participates in a time recording race; receiving an identification (ID) output from an electronic tag by an activated antenna coil embedded in the number label with a wireless power signal generated by an antenna array, and measuring a measuring point time record, to then combine the received ID with the measuring point pass time record; and making the ID combined measuring point pass time records into a database.

There is also provided a time record measurement system using an antenna tag embedded number label for measuring a time record of each race runner through wireless identification, the time record measurement system comprising: an antenna tag embedded number label attached on the chest or back of each race runner who participates in a time recording race; an antenna array for receiving an identification (ID) output from each antenna tag attached on each race runner which is driven by a wireless power signal when each race runner who participates in the race passes through a time record measuring point, and transmitting the received identification (ID), a time record measuring unit for initializing the time record measurement system, setting a time indicating a start of the time recording race, combining a time record with the race runner's ID transmitted through the antenna array, and transmitting the measured time record of each race runner; and a database management host computer for making the ID of each antenna tag and the measured time record, read and transmitted by the time record measurement unit as a database.

Preferably, the antenna tag embedded number label is made of two sheets of thin-film paper, cloth, plastic, vinyl, or metal as a main material.

Preferably, the antenna tag embedded number label includes a space in a number label, where an entry number of each registered race runner is printed.

Here, the antenna array is a goal-post shaped antenna array or iron-bar shaped antenna array installed at a height where the heads of the race runners do not contact, to thereby induce a wireless power signal to an antenna coil in the antenna tag embedded number label attached on the chest or back of each race runner and activate the antenna tag when each race runner passes below the antenna array.

Also, the time record measurement system further comprises a step-board shaped antenna array for inducing a wireless power signal to the antenna coil in the antenna tag embedded number label which is attached on the upper cloth of each race runner and activating the antenna tag when each small race runner such as children passes over the antenna array.

### BRIEF DESCRIPTION OF THE DRAWINGS

The above objects and other advantages of the present invention will become more apparent by describing the preferred embodiment thereof in more detail with reference to the accompanying drawings in which:

FIG. 1 is a schematically exploded perspective view showing an antenna tag embedded number label for measuring race runners' time records through wireless identification (ID) according to an embodiment of the present invention;

FIGS. 2A and 2B are a perspective view and a side view respectively showing a time record measurement system using an antenna tag embedded number label for measuring race runners' time records through wireless identification (ID) according to an embodiment of the present invention;

FIG. 3 is a circuit diagram schematically showing a circuit performing wireless identification (ID) between an antenna tag embedded number label and an antenna array which are adapted in the FIG. 2 time record measurement system; and

FIG. 4 is a flowchart view for explaining a wireless identification (ID) time record measurement method using an antenna tag embedded number label according to an embodiment of the present invention.

FIGS. 5A through 5C are perspective views showing various forms of am antenna array, respectively.

### DETAILED DESCRIPTION OF THE INVENTION

An antenna tag embedded number label, and a time record measurement method and system for measuring a race runner's time record through wireless identification according to a preferred embodiment of the present invention will be described in more detail with reference to the accompanying drawings.

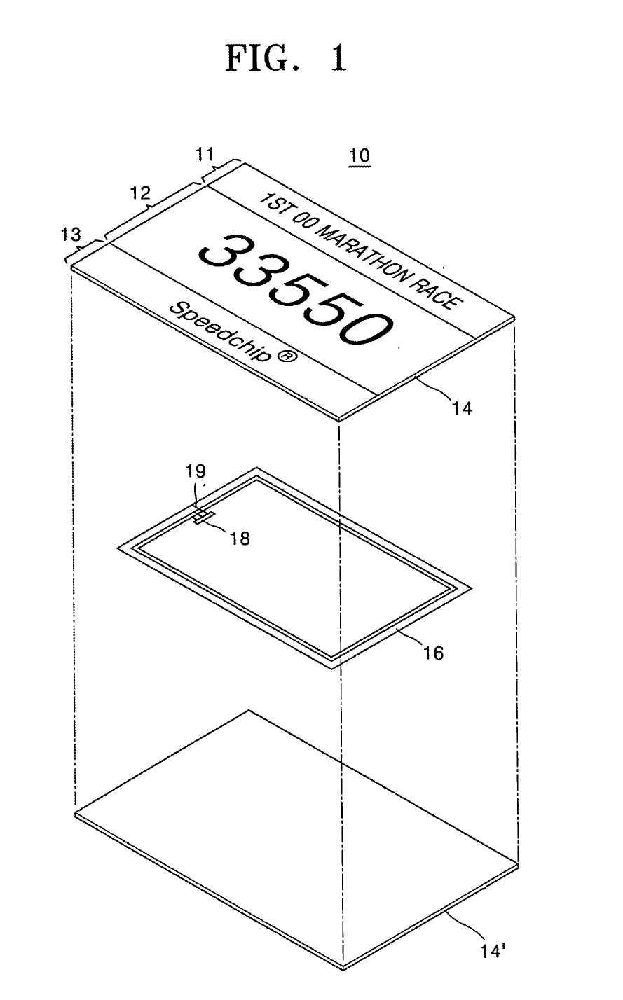

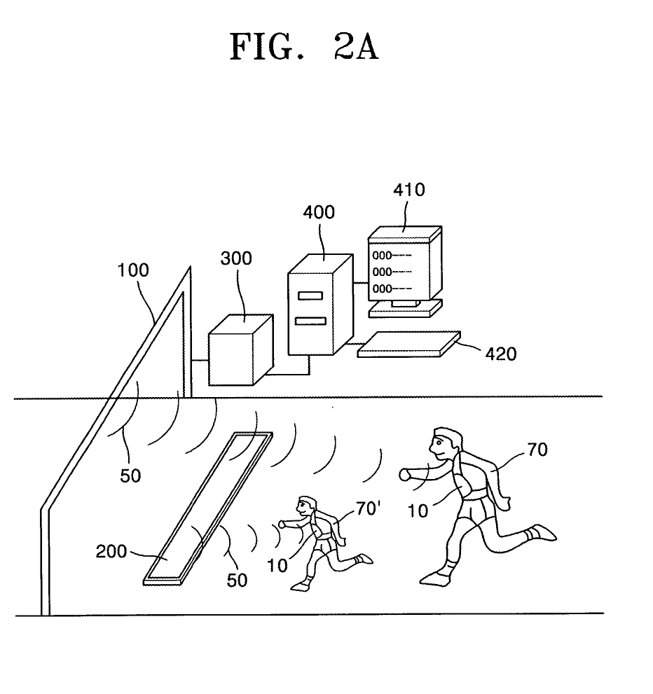

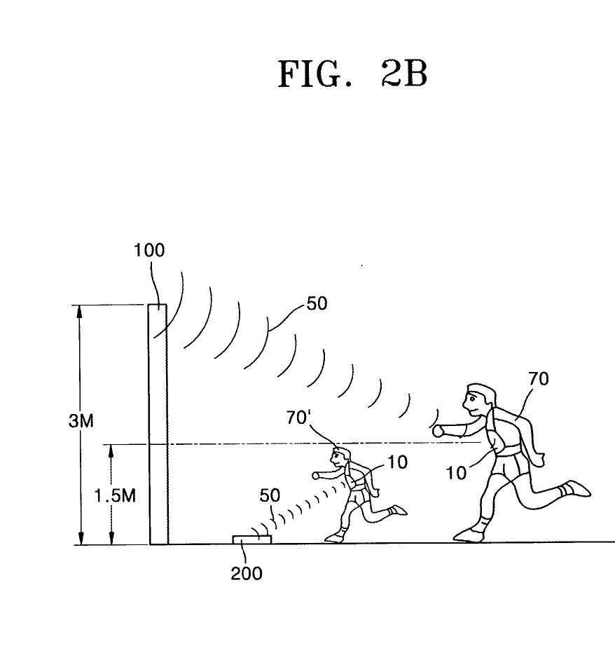

As shown in FIG. 1 showing an antenna tag embedded number label for measuring race runners' time records through wireless identification (ID) according to an embodiment of the present invention, an antenna tag embedded number label 10 has an antenna coil 16 and an electronic tag 18 between an upper cover 14 and a lower cover 14′. The antenna coil 16 is connected to the electronic tag 18 by a connection wire 19 and then activated by an antenna array which is shown as a reference numeral 100 or 200 in FIG. 2A or 2B, to thereby receive a wireless power signal from the antenna array and transmit a key value of the electronic tag 18 to the antenna array. The antenna coil 16 and the electronic tag 18 are printed and embedded on any one inner surface of the upper and lower covers 14 and 14′ so as to be inserted between the upper cover 14 and the lower cover 14′. Then, the upper cover and the lower cover are overlapped and compressed over each other, to thereby fabricate an antenna tag embedded number label 10. Then, a race name is printed in a race name indication portion 11 on the outer surface of the upper cover 14, a race runner's number is printed in an entry number indication portion 12, and a race sponsor name is printed in a sponsor name indication portion 13. The antenna tag embedded number label 10 is distributed to be attached on the upper cloth of each race runner. Here, the race name indication portion 11, the entry number indication portion 12 and the sponsor name indication portion 13 are originally left empty and printed as necessary for use in a time record race. By doing so, the antenna tag embedded number labels on which various indications are not printed can be used for other time record races, to thereby save a number label fabrication cost. In particular, the entry number indication portion 12 is left empty so that an entry number of each registered race runner is printed during registration. In this case, a desired number of each race runner may be printed in the entry number indication portion 12 without duplication, in which case an additional fee may be charged or not. Also, since the antenna tag embedded number labels need not be attached on both the chest and back of each race runner, only one antenna tag embedded number label of two number labels may be distributed. The antenna tag embedded number label is made of two sheets of thin-film paper, cloth, plastic, vinyl, or metal as a main material. It is preferable that the antenna tag embedded number label is made of two sheets of paper which are overlapped and compressed. Here, the antenna coil 16 and the electronic tag 18 are disclosed in Korean Laid-open Publication No. 1999-78504 published on Nov. 5, 1999, which was registered as a Korean Patent Registration No. 10-312188 to the same applicant, and in U.S. patent application Ser. No. 09/907,640 filed on Jul. 19, 2001, of which the priority applications are Korean Patent Application No. 2001-20040 and Korean Utility Model Application No. 2000-20699 filed by the same applicant. Therefore, the detailed description of the antenna coil 16 and the electronic tag 18 will be omitted. The antenna coil 16 is activated by a wireless power signal induced from an external antenna array, to thus supply power to the electronic tag 18 and wirelessly transmit an identification (ID) of each race runner through the antenna coil 16 from the electronic tag 18 to the antenna array.

A time record measurement system for measuring a time record of each race runner using the antenna tag embedded number label 10 according to the present invention will be described with reference to FIGS. 2A and 2B. FIGS. 2A and 2B are a perspective view and a side view respectively showing a time record measurement system using an antenna tag embedded number label for measuring race runners' time records through wireless identification (ID) according to an embodiment of the present invention.

As shown in FIGS. 2A and 2B, each race runner should attach identically sized number labels 10 on the chest and back according to the standard recommended by International or Korean Athletic Association. Up to now, since an antenna tag is attached to a shoe of each race runner, an antenna array is naturally installed on the ground so that a distance between the antenna tag and the antenna array becomes closer. Now that an antenna tag embedded number label 10 is attached on the upper cloth of each race runner in the present invention, an antenna array need not be installed on the ground. In the present invention, the antenna array is fabricated in the form of a goal-post or an iron-bar having a height which is higher than the heights of general rae runners. Thus, when a race runner who is attached with an antenna tag embedded number label 10 passes below the goal-post shaped antenna array, a wireless power induction 50 is accomplished from the antenna array 100 to the antenna coil 16 of FIG. 1. An identification (ID) for each race runner of the electronic tag 18 which has been wirelessly power communicated with the antenna array through the antennal coil 16 is sent to a time record measurement unit 300 and then combined with a measured time record. The ID combined with the measured time record is sent to a database management computer 400 to be made into a database, and output and transmitted as desired through an Internet communications network, a wired telephone communications network or a wireless mobile communications network, by use of a keyboard 420 and a monitor 410. Here, both a tall race runner 70 and a small race runner 70′ are attached with the same sized number labels 10 whose entry numbers differ from each other. As a result, the heights of the number labels from the ground differ from each other in dependence upon the height of the race runners. Thus, a step-board shaped antenna array 200 is installed on the ground for small race runners 70′. Accordingly, when the small race runners 70′ pass over the step-board shape antenna array 200, the antenna coil 16 is activated by the antenna array 200 to thereby transmit an ID of each race runner to a time record measurement unit 300 through the antenna coil 16 and the antenna array 200 to then measure a time record of each race runner. Typically, a radio frequency (RF) wireless transmission induction distance between an antenna array and an antenna coil is 0 to 2 meters. Thus, the goal-post or iron-bar shaped antenna array 100 may be constructed as high as 3 meters. In the case of small race runners such as children which are not higher than 1.5 meters, a step-board shaped antenna array 200 is installed on the ground. Thus, in the case that all race runners are higher than 1.5 meters, such a step-board antenna array need not be installed on the ground.

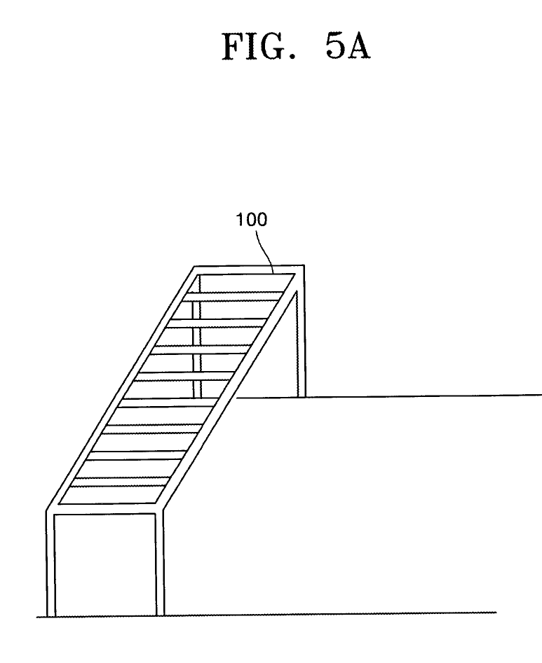

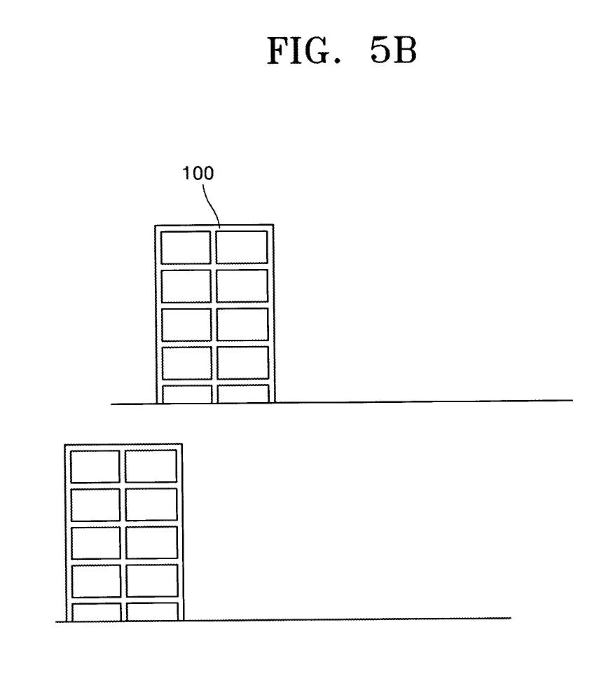

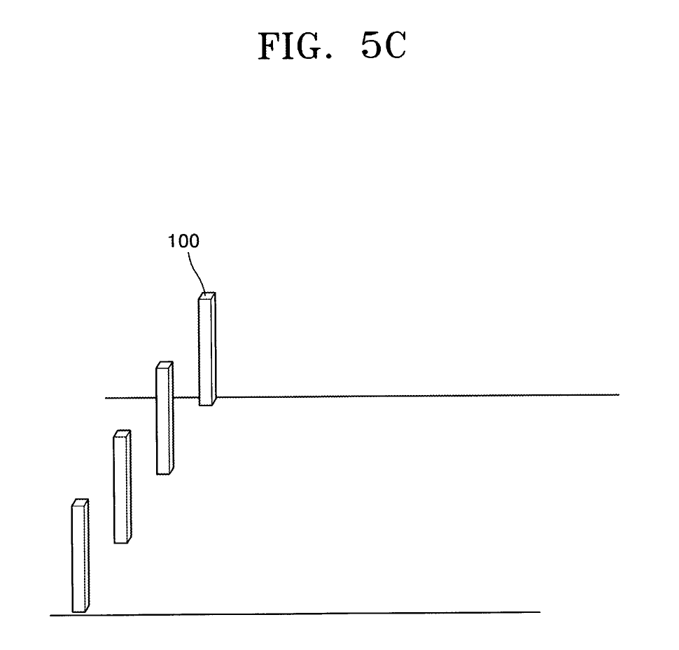

Also, the antenna array 100 applied to the present invention can be fabricated in various forms as shown in FIGS. 5A through 5C. FIG. 5A shows a combination of two or more goal-post shaped antenna arrays, and FIG. 5B shows a combination of two or more post-shaped antenna arrays without having any bars which connect the left- and right-hand post-shaped antenna arrays in the form of a bridge, and FIG. 5C shows a combination of transversely arranged post-shaped antenna arrays without having any bars which connect between the post-shaped antenna arrays in the form of a bridge. These various types of the antenna arrays play a role of performing wireless communications between the antenna array and the antenna tag embedded number label more reliably.

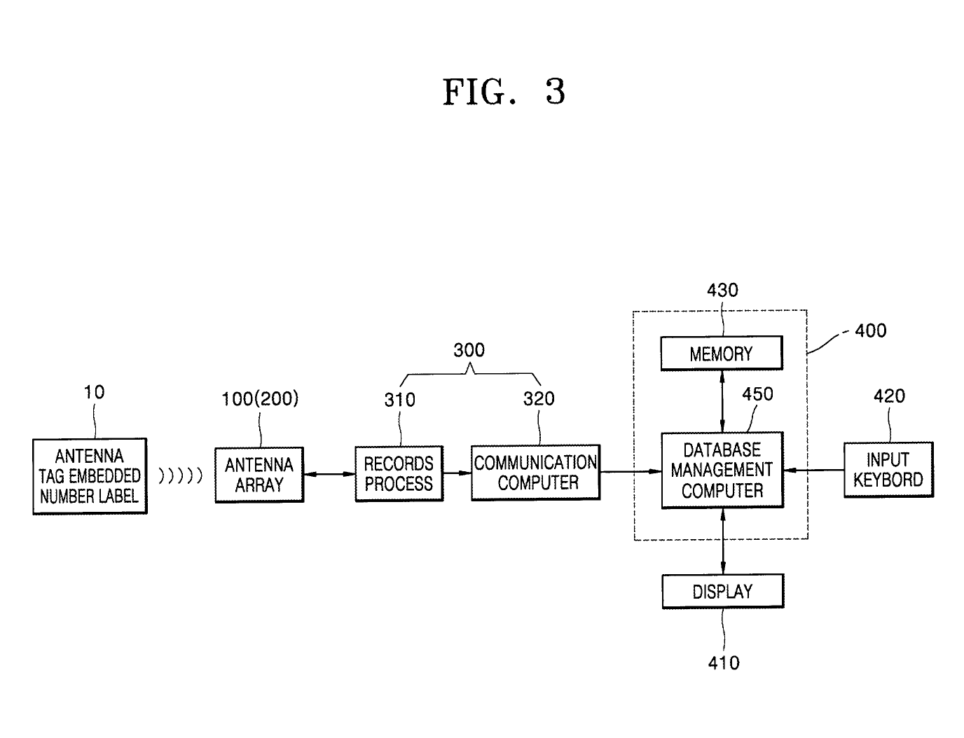

FIG. 3 is a circuit diagram schematically showing a circuit performing wireless identification (ID) between an antenna tag embedded number label and an antenna array which are adapted in the FIG. 2 time record measurement system. As can be seen from the FIG. 3 circuit diagram, the time record measurement system using the antenna tag embedded number label according to the present invention is not so different from the existing time record measurement system using an existing shoe-attached antenna tag and an existing step-board shaped antenna array. However, in order to reduce a manufacturing cost of an antenna tag embedded number label which is used ephemerally in the present invention, only a key value of each race runner is stored in an electronic tag 18 in the antenna tag embedded number label 10. When the antenna coil 16 is activated by a wireless power signal from the antenna array 100 or 200, the electronic tag 18 wirelessly transmits a key value of the race runner through the antenna coil 16, to then be transmitted to a time record measurement unit 300 through the goal-post or iron-bar shaped antenna array 100, or the step-board shaped antenna array 200. A time record processor 310 in the time record measurement unit 300 combines the race runner's key value such as his or her ID with a time record of the race runner, to then transmit his or her ID combined with his or her time record to a time record management computer 400 through a communication computer 320. Accordingly, a database management computer 450 in the time record management computer 400 combines the time record combined ID with personal data of the race runner stored in a memory 430, to then be stored into a database. A time record operator can transmit each race runner's time record data as desired through an Internet communications network or a telephone communications network which is not shown in the drawings, by using an input keyboard 420 and a display 410.

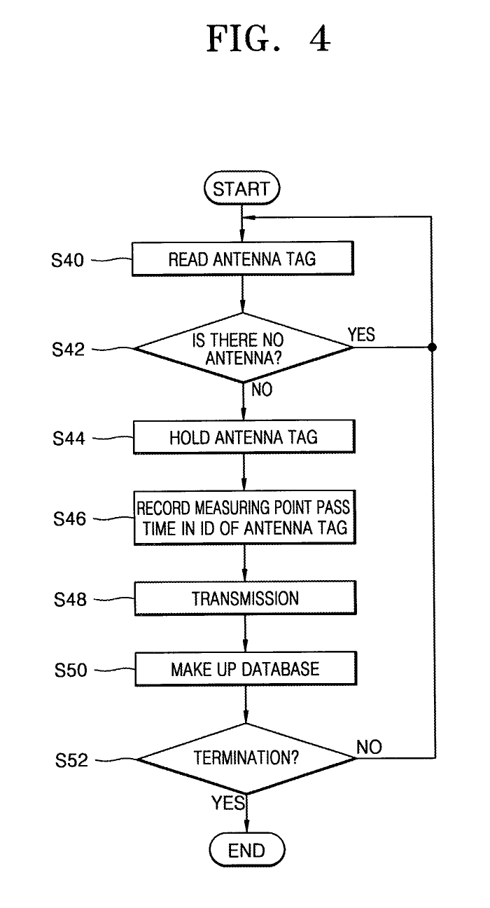

FIG. 4 is a flowchart view for explaining a wireless identification (ID) time record measurement method using an antenna tag embedded number label according to an embodiment of the present invention. In FIG. 4, steps following a step of reading an antenna tag during procession of a race has been shown after the time record measurement system has been initialized. An initialization and inspection of the other units and a wireless identification between each antenna array and each antenna tag are disclosed in Korean Laid-open Publication No. 1999-78504 published on Nov. 5, 1999, which was registered as a Korean Patent Registration No. 10-312188 to the same applicant, and in U.S. patent application Ser. No. 09/907,640 filed on Jul. 19, 2001, of which the priority applications are Korean Patent Application No. 2001-20040 and Korean Utility Model Application No. 2000-20699 filed by the same applicant. Thus, the detailed description thereof will be omitted.

When the time record measurement system has been initialized and inspected and a race starts, an identification (ID) in an antenna tag embedded number label 10 is read (S40) at a time record measuring point in order to measure a time record such as a pass time record or a full-distance running time of each race runner who passes through a certain race interval or runs the whole distance of a race. In more detail, a goal-post or iron-bar shaped antenna array 100 and a step-board shaped antenna array 200 which is installed on the lane at the time record measuring point transmit radio frequency (RF) power in the air together with departure or start of each race runner. As soon as each race runner who participate in a marathon or waking race passes a measuring point lane on which the antenna array 100 or 200 is installed, the antenna coil 16 in the antenna tag embedded number label 10 receives the RF power transmitted from the antenna array 100 or 200 and is activated and driven by the received RF power. Accordingly, the electronic tag 18 wirelessly transmits an ID specifying each race runner through the antenna coil 16. In step S42, the time record measurement system checks whether or not an antenna tag exists. If there exists an antenna tag, the system proceeds step S44, and if not the system checks again whether or not an antenna tag exists in step S40.

As described above, an ID signal wirelessly transmitted from each electronic tag 18 is received by the antenna array 100 or 200. The system holds the antenna tag whose ID has been read so that the ID wirelessly transmitted from the antenna tag whose ID has been already received previously is not received again by the antenna array 100 or 200 (S44).

A time record measurement unit 300 which reads out the ID of the electronic tag 18 and the time record of the race runner combines the ID of the electronic tag with a pass time and then transmits the pass time combined ID (S46 and S48). Then, a time record management computer 400 makes a database with the time record of each race runner (S50) and then terminates (S52).

As described above, the present invention has been described with respect to a marathon or walking race. However, the present invention can be applied to all time record races in which race runners run and pass a predetermined interval such as an automobile race, horse race, and a cycling race.

As described above, an antenna tag embedded number label, and a runner's recording measurement method and system using the same according to the present invention are provided, in which a number label is embedded and integrated in an antenna tag. Accordingly, a problem incapable of measuring a time record of a race runner due to an inability of identification of a bar code which has been screened by his or her body or the other race runners' bodies, and problems of fabricating a RF chip embedded with an antenna tag and distributing the fabricated RF chip to each race runner, in addition to a number label, in the case of a race operator, and attaching both an antenna tag and a number label separately to thereby cause much burden, can be solved. Thus, the present invention integrates the antenna tag with the number label, to thereby provide cost savings and conveniences to race operators and race runners. Also, the present invention fabricates a sheet of a number label having an antenna coil and a memory storing only a key value as an antenna tag. Thus, in the case that each race runner's entry number is printed when race runners registers for a race, a number label manufacturing cost can be saved.

The present invention is not limited to the above-described embodiments. It is apparent to one who has an ordinary skill in the art that there may be many modifications and variations within the same technical spirit of the invention.

What is claimed is:

1. An antenna tag embedded number label comprising:
an antenna tag having an antenna coil wirelessly power activated by an external antenna array; and
an electronic tag transmitting a stored key value by the activated antenna coil,
wherein the antenna coil and the electronic tag are embedded and integrated in the number label, when the number label is fabricated according to a predetermined standard so as to be attached on the chest or back of each race runner to see an entry number of each race runner.

2. The antenna tag embedded number label of claim 1, wherein the antenna tag embedded number label includes a space in a number label, where an entry number of each registered race runner is printed.

3. The antenna tag embedded number label of claim 1 or 2, wherein the antenna tag embedded number label is made of two sheets of thin-film paper, cloth, plastic, vinyl, or metal as a main material.

4. A time record measurement method using an antenna tag embedded number label for measuring a time record of each race runner through wireless identification, the time record measurement method comprising the steps of:
attaching the antenna tag embedded number label on the chest or back of each race runner who participates in a time recording race;
receiving an identification (ID) output from an electronic tag by an activated antenna coil embedded in the number label with a wireless power signal generated by an antenna array, and measuring a measuring point time record, to then combine the received ID with the measuring point pass time record; and
making the ID combined measuring point pass time records into a database.

5. A time record measurement system using an antenna tag embedded number label for measuring a time record of each race runner through wireless identification, the time record measurement system comprising:
an antenna tag embedded number label attached on the chest or back of each race runner who participates in a time recording race; an antenna array for receiving an identification (ID) output from each antenna tag attached on each race runner which is driven by a wireless power signal when each race runner who participates in the race passes through a time record measuring point, and transmitting the received identification (ID);
a time record measuring unit for initializing the time record measurement system, setting a time indicating a start of the time recording race, combining a time record with the race runner's ID transmitted through the antenna array, and transmitting the measured time record of each race runner; and
a database management host computer for making the ID of each antenna tag and the measured time record, read and transmitted by the time record measurement unit as a database.

6. The time record measurement system of claim 5, wherein the antenna array is a goal-post shaped antenna array or iron-bar shaped antenna array installed at a height where the heads of the race runners do not contact, to thereby induce a wireless power signal to an antenna coil in the antenna tag embedded number label attached on the chest or back of each race runner and activate the antenna tag when each race runner passes below the antenna array.

7. The time record measurement system of claim 5 or 6, wherein the time record measurement system further comprises a step-board shaped antenna array for inducing a wireless power signal to the antenna coil in the antenna tag embedded number label which is attached on the upper cloth of each race runner and activating the antenna tag when each small race runner such as children passes over the antenna array.
